(19) United States
(12) Patent Application Publication
(10) Pub. No.: US 2024/0361468 A1
(43) Pub. Date: Oct. 31, 2024

(54) SATELLITE NAVIGATION ACCELEROMETER

(71) Applicant: UTI Limited Partnership, Calgary (CA)

(72) Inventors: Naser EL-SHEIMY, Calgary (CA); Yiran LUO, Calgary (CA)

(21) Appl. No.: 18/646,965

(22) Filed: Apr. 26, 2024

Related U.S. Application Data
(60) Provisional application No. 63/498,401, filed on Apr. 26, 2023.

(51) Int. Cl. G01S 19/42; G01S 19/29

(52) U.S. Cl. CPC G01S 19/42; G01S 19/29

(57) ABSTRACT

Systems and methods for determining a user's absolute acceleration/deceleration on an Earth based reference frame. Signals from multiple satellites are received and the Doppler rate for each satellite is extracted using baseband signal processing. Then, using each satellite's ephemeris, the acceleration/deceleration and Earth frame position of each satellite is determined. The user's absolute position is then used, along with each satellite's position to calculate direction cosine vector projections for each satellite. The user's absolute acceleration/deceleration is then calculated using the various direction cosine vector projections, the various satellite acceleration/deceleration values, and each satellite's Doppler rates. The resulting absolute acceleration/deceleration can then be used for more accurate navigation solutions.

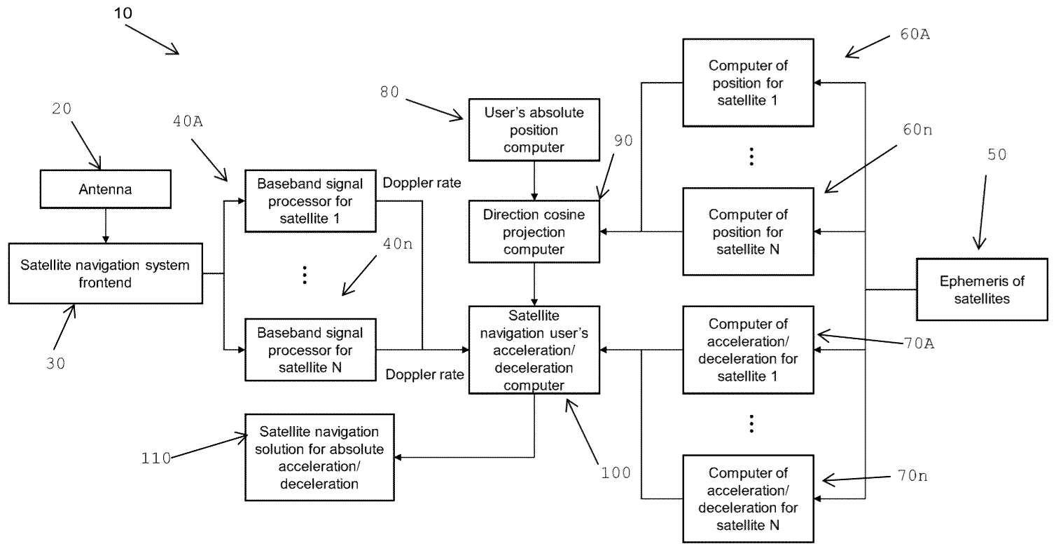

### RELATED APPLICATIONS

This application is a non-provisional patent application that claims the benefit of U.S. Provisional Patent Application No. 63/498,401 filed on Apr. 26, 2023, the entire disclosure of which is incorporated herein by reference.

### TECHNICAL FIELD

The present invention relates to satellite-based navigation. More specifically, the present invention relates to systems and methods for determining a user's absolute acceleration/deceleration.

### BACKGROUND

The increasing use of GNSS equipment by the public has fuelled a call for more accurate and more capable equipment. As is known, GNSS systems rely on signals from multiple satellites to determine a GNSS receiver's location. Unfortunately, such signals are subject to the Doppler effect, and this has been known to introduce errors.

Current commercial GNSS receivers are unable to produce Doppler rate measurements. One reason is that the global navigation satellite system (GNSS) user's absolute acceleration is too weak to observe through the line-of-sight (LOS) signal Doppler. Another reason is that the incomplete baseband signal processing techniques on which the current receivers depend are inadequate. More specifically, the length of coherent integration time used in current receivers (a typical value is 20 ms) is not long enough to recognize the change of the Doppler frequency of LOS GNSS signals in the baseband. Instead, a way to estimate such signal parameters relies on differencing between-epoch Doppler measurements or double-differencing the carrier phases, negatively introducing extra additive noise power to estimates that are not expected, especially in challenging environments.

As known, the Doppler frequency change is critical for carrier-based positioning techniques, such as cycle slip detection. It would, therefore, be desirable to be able to accurately estimate this Doppler frequency change using a GNSS signal based procedure. Should this procedure be possible, this would avoid the unexpected noise power caused by the differencing operation, thereby theoretically elevating the upper bound of the estimating accuracy of Doppler frequency change (or Doppler rate in the signal processing process). This would tend to potentially enhance the positioning performance.

The accuracy of the estimated Doppler frequency change is, however, not the only issue with current GNSS systems. Another issue is that of determining a receiver's (and hence a user's) acceleration/deceleration. There is a need for systems and methods that can provide better performance and better accuracy than current GNSS systems. Preferably, such systems and methods are able to provide more accurate estimates of the Doppler frequency change and to provide a user's absolute acceleration/deceleration.

### SUMMARY

The present invention provides systems and methods for determining a user's absolute acceleration/deceleration on an Earth based reference frame. Signals from multiple satellites are received and the Doppler rate for each satellite is extracted using baseband signal processing. Then, using each satellite's ephemeris, the acceleration/deceleration and Earth frame position of each satellite is determined. The user's absolute position is then used, along with each satellite's position to calculate direction cosine vector projections for each satellite. The user's absolute acceleration/deceleration is then calculated using the various direction cosine vector projections, the various satellite acceleration/deceleration values, and each satellite's Doppler rates. The resulting absolute acceleration/deceleration can then be used for more accurate navigation solutions.

In a first aspect, the present invention provides a method for determining a user's absolute acceleration/deceleration, the method comprising:
receiving received signals from a plurality of satellites;
extracting Doppler rate measurements for each of said plurality of satellites by baseband signal processing from said received signals;
determining position coordinates of each of said plurality of satellites;
determining an acceleration/deceleration of each of said plurality of satellites;
determining said user's absolute position;

-determining direction cosine vector projections for each of said plurality of satellites based on said position coordinates of said plurality of satellites, said acceleration/deceleration of said plurality of satellites, and said user's absolute position; and
determining said user's absolute acceleration/deceleration based on said direction cosine vector projections for each of said plurality of satellites and said Doppler rate measurements for each of said plurality of satellites.

In a second aspect, the present invention provides a system for determining a user's absolute acceleration/deceleration, the system comprising:
a signal receiver for receiving received signals from a plurality of satellites;
a baseband signal processor for extracting Doppler rate measurements for each of said plurality of satellites from said received signals;
a data processor for extracting ephemeris for each of said plurality of satellites, said ephemeris being extracted as said baseband signal processor processes said received signals, said data processor determining position coordinates and acceleration/deceleration for each of said plurality of satellites based on said ephemeris;
a hardware module for determining said user's absolute position;
a first calculation module for determining direction cosine vector projections for each of said plurality of satellites based on said position coordinates of said plurality of satellites, said acceleration/deceleration of said plurality of satellites, and said user's absolute position;
a second calculation module for determining said user's absolute acceleration/deceleration based on said direction cosine vector projections for each of said plurality of satellites and said Doppler rate measurements for each of said plurality of satellites.

In a third aspect, the present invention provides computer readable media having encoded thereon computer readable and computer executable instructions that, when executed, implements a method for determining a user's absolute acceleration/deceleration, the method comprising:
receiving received signals from a plurality of satellites;
extracting Doppler rate measurements for each of said plurality of satellites by baseband signal processing from said received signals;
determining position coordinates of each of said plurality of satellites;
determining an acceleration/deceleration of each of said plurality of satellites;
determining said user's absolute position;
determining direction cosine vector projections for each of said plurality of satellites based on said position coordinates of said plurality of satellites, said acceleration/deceleration of said plurality of satellites, and said user's absolute position; and
determining said user's absolute acceleration/deceleration based on said direction cosine vector projections for each of said plurality of satellites and said Doppler rate measurements for each of said plurality of satellites.

### BRIEF DESCRIPTION OF THE DRAWING

The embodiments of the present invention will now be described by reference to the Figure, in which identical reference numerals indicate identical elements and which is a block diagram of a system and method according to one aspect of the present invention.

### DETAILED DESCRIPTION

To better understand the present invention, the reader is directed to the listing of citations at the end of this description. For ease of reference, these citations and references have been referred to by their listing number throughout this document. The contents of the citations in the list at the end of this description are hereby expressly incorporated by reference herein in their entirety.

Regarding the present invention, it is well-known that providing Doppler rate measurements via baseband processing manipulation can be exceptionally challenging. Current GNSS signal processing techniques are designed deeply and originally upon the conventional fast Fourier transform (FFT) concept and its frequency resolution limits the boundary of parameter estimation of unknown signals.

One issue with current methods is that the Doppler rate of a single-channel GNSS satellite (a typical value is 0.8 Hz/s) is weak, avoiding fast and accurate estimation of this unknown parameter. It can be inferred that the estimating process will accelerate if less useful signal power is lost in the baseband processing. Extending the coherent integration time is a candidate for effectively preserving the carrier and code phase information, exploiting more LOS signal information in estimation. One possible solution is to switch techniques. Specifically, the use of the digital fractional Fourier transform (FrFT) [6] to replace the FFT in baseband processing allows for the simultaneous estimation of the instantaneous Doppler shift and of the averaging Doppler rate, enabling the measurement of Doppler rates to be possible.

Being able to measure Doppler rates from GNSS receivers allows for the calculation of a user's acceleration computation.

To assist in the above, a method of GPS satellite acceleration computation using the broadcast navigation message is known and is described in detail in [2].This method makes it possible to estimate the user's on-the-fly acceleration and the change of clock drifts.

For clarity, the reader is directed to references [3]-[5] for details regarding GNSS baseband processing.

Referring to the Figure, a block diagram of modules that implement one aspect of the present invention is illustrated. As can be seen, the system 10 is for determining a user's absolute acceleration/deceleration. The system uses an antenna 20 to receive radio signals from multiple satellites. This single antenna can also be extended to an antenna array. These radio signals are then passed to a satellite navigation front end subsystem 30. The subsystem 30 produces/converts these received signals so that multiple baseband signal processors (one for each satellite) 40A . . . 40n can produce/estimate the Doppler rate for each of the satellites.

At the other end of the system 10, the ephemeris 50 of the various satellites (a plot/table of each satellite's position at specific times) is used to feed modules 60A . . . 60n that determine each satellite's position. The ephemeris of the various satellites is also used to feed modules 70A . . . 70n that calculate the acceleration/deceleration for each of the satellites.

The system 10 also includes a module 80 for determining a user's (or the GNSS receiver's) absolute position. This absolute position, based on an Earth-centric frame, is sent to a computational module 90 for calculating direct cosine projections for each of the satellites. This computational module 90 also receives the output of the modules 60A . . . 60n that determine each satellite's position. The positions of these satellites are time synchronized with the absolute position of the output of the computational module 80.

The direct cosine projections for each of the satellites are sent to a computational module 100 that also receives the computed acceleration/deceleration for each of the satellites. This module 100 also receives the Doppler rate for each satellite from the baseband signal processors 40A . . . 40n. These Doppler rates are time synchronized with the positions of the satellites that are the output of the modules 60A . . . 60n. With all these inputs, this module 100 calculates the absolute acceleration/deceleration (Earth based frame) of the user based on the calculated Earth frame acceleration/deceleration of each satellite, each satellite's Doppler rate, and each satellite's direction cosine projection. The result is useful for determining solutions 110 for absolute acceleration/deceleration of the GNSS receiver and is useful in producing greater accuracy navigation solutions.

In terms of details for the various components of the system, for the baseband signal processor 40A . . . 40n for each of the satellites, these blocks produce the Doppler rate for each satellite. The blocks are baseband processors for the digitized and quantified intermediate-frequency (IF) signals and are used to demodulate the satellite navigation signals (such as GNSS or LEO satellite system signals). These blocks extract the Doppler rate measurements for computing the acceleration/deceleration navigation solutions. For an example of a baseband signal processor that generates the Doppler rate measurements by processing the IF signals, the reader is referred to [1]. Other techniques that achieve the same goal (i.e., generating the Doppler rate measurements through baseband signal processing) may also be used for this block.

Regarding the module 80 of the system 10, this module computes/determines the user's absolute position in the Earth coordinate frame. The position solutions produced by this block are not constrained with a high-accuracy condition. For example, the position uncertainty can be in the dozens or hundreds of meters. The component used in this module may be a standalone GNSS receiver, an inertial navigation sensor (calibrated into the Earth coordinate frame), an integrated GNSS/inertial sensor navigation system, a navigation device that take advantage of signals of opportunity (e.g. signals of opportunity other than GNSS signals), or any other suitable device/component.

The ephemeris 50 of the various satellites are, as known to those in the art, simply the positions of each satellite at specified times. These data points for the various satellites can be obtained from the extracted broadcast ephemeris during the real-time baseband processing, from the memory of the satellite navigation system device, or from the transmitted data from other external sources, such as wireless communication networks.

The modules 60A . . . 60n for computing/determining each satellite's position may be a suitable processor with suitable computer readable and computer executable instructions (i.e., suitable software) for finding the position based on the ephemeris. Based on the known satellite orbital information from the ephemeris, the modules compute the position coordinates in the Earth frame of all the available satellites. The algorithm related to this block/module would be clear to the person skilled in the art.

The modules 70A . . . 70n for computing/determining each satellite's acceleration/deceleration may, again, involve a suitable processor and suitable software. These blocks/modules compute the acceleration/deceleration in 3D space with respect to the Earth frame of all the available satellites based on the known satellite orbital information from the ephemeris. The computation method used may refer to but is not limited to, that disclosed in the reference [2]. Similarly, reference [2] provides a detailed methodology for the computation of GPS satellite velocity and acceleration using the broadcast navigation message, offering an opportunity to estimate the user's acceleration on the receiver end.

For the direction cosine projection module 90, this module implements a mathematical model as follows:

$$H {=}^{Δ} [ \begin{matrix}- {( {l}^{( 1 )} )}^{T} & 1 \\ - {( {l}^{( 2 )} )}^{T} & 1 \\ ⋮ & ⋮ \\ - {( {l}^{( L )} )}^{T} & 1\end{matrix} ]$$

where H represents the design matrix; superscript {(1), (2), . . . (L)} denotes the set of channel indexes and L is the total channel number relative to the available satellites (each channel processes the IF signal received from a single satellite); lₖ^{j} is the unit direction cosine vector with respect to the satellite j; k is the index of the computation epoch.

For the module 100 that computes the user's absolute acceleration/deceleration, a user's position and clock bias error are traditionally computed and optimized from the coarse initial 3D position coordinates using nonlinear least square (NLS) regression. No less than four satellites (considering a single constellation) are used to estimate four unknowns. The user's acceleration computation resembles the position calculation except for the measurements (Doppler rates generated via the baseband processing as noted above) and unknown states (user's accelerations and clock drift rate). It should also be noted that more than four satellites are needed to compute extra between-constellation or between-frequency biases of the clock drift rate if multiple GNSS constellations or/and multi-frequency band signals are involved.

The computation of the brand-new navigational solutions (that is the 3D-space user's absolute acceleration and the clock drift rate) will be further below.

At first, a pseudorange model ρ^{j} can be expressed as

$${ρ}^{j} {=}^{Δ} {r}^{j} + c δ {t}_{r} - c δ {t}^{j} + {B}_{ρ , atm}^{j} + {ε}_{ρ}^{j} \qquad ( 1 )$$

where the superscript j denotes the satellite number; r′ is the geometry distance, δt, is the local clock bias error, δt^{j} is the satellite clock bias error, B_{ρ,atm}^{j} is the atmospheric delay error, ε_{ρ}^{j} is the remained pseudorange random error, and c is the speed of light.

Then, the derivative of (1) with respect to the time variable yielding the pseudorange rate \dot{ρ}^{j} can be modeled as

$${\dot{ρ}}^{j} {=}^{Δ} {\dot{r}}^{j} + c δ {\dot{t}}_{r} - c δ {\dot{t}}^{j} + {ε}_{\dot{ρ}}^{j} \qquad ( 2 )$$

where δ\dot{t}ᵣ and δ\dot{t}^{j} are the local and satellite clock drift error, ε_{\dot{ρ}}^{j} is the remained pseudorange rate random error, the change rate of the atmospheric delay error is not significant so that it is omitted in this model, \dot{r}^{j} is the change rate of the geometry distance.

Analogously, the 2nd-order pseudorange rate (i.e., the change of pseudorange rate) \ddot{ρ}^{j} can be modeled via the derivative of (2) with respect to the time variable, that is,

$${\ddot{ρ}}^{k} {=}^{Δ} {\ddot{r}}^{j} + c δ {\ddot{t}}_{r} + {ε}_{\ddot{ρ}}^{j} \qquad ( 3 )$$

where δ\ddot{t}ᵣ denotes the local clock drift rate (i.e., the change rate of the clock drift error), ε_{\ddot{ρ}}^{j} is the remained 2nd-order pseudorange rate range error, \ddot{r}^{j} is the 2nd-order pseudorange rate (i.e., the change rate of the pseudorange rate) which has a relationship with the user's and the satellite's acceleration in the Earth-centered Earth-fixed (ECEF) coordinate frame, that is,

$${\ddot{r}}^{j} {=}^{Δ} ( {a}^{j} - a ) \cdot {l}^{j} \qquad ( 4 )$$

with

$$a {=}^{Δ} [ \begin{matrix}\ddot{x} \\ \ddot{y} \\ \ddot{z}\end{matrix} ]$$

where a^{j} and a are the satellite acceleration and the user's acceleration vectors in the ECEF frame, respectively, (⋅) is the inner product operator; l^{j} is the unit direction cosine vector with respect to the satellite j.

After that, combining (3) and (4), an equation can be formed as

$$H Δ \ddot{x} = \ddot{b} - {ε}_{\ddot{ρ}}$$

with

$$\ddot{b} {=}^{Δ} [ \begin{matrix}- λ {\tilde{μ}}^{( 1 )} - {\hat{\ddot{r}}}^{( 1 )} - c δ {\hat{\ddot{t}}}_{r} \\ - λ {\tilde{μ}}^{( 2 )} - {\hat{\ddot{r}}}^{( 2 )} - c δ {\hat{\ddot{t}}}_{r} \\ ⋮ \\ - λ {\tilde{μ}}^{( L )} - {\hat{\ddot{r}}}^{( L )} - c δ {\hat{\ddot{t}}}_{r}\end{matrix} ] \\ Δ \ddot{x} {=}^{Δ} [ \begin{matrix}Δ \ddot{x} \\ Δ \ddot{y} \\ Δ \ddot{z} \\ c Δδ {\ddot{t}}_{r}\end{matrix} ] {=}^{Δ} [ \begin{matrix}\ddot{x} - {\ddot{x}}_{0} \\ \ddot{y} - {\ddot{y}}_{0} \\ \ddot{z} - {\ddot{z}}_{0} \\ c ( δ {\ddot{t}}_{r} - δ {\ddot{t}}_{r , 0} )\end{matrix} ] \\ H {=}^{Δ} [ \begin{matrix}- {( {l}^{( 1 )} )}^{T} & 1 \\ - {( {l}^{( 2 )} )}^{T} & 1 \\ ⋮ & ⋮ \\ - {( {l}^{( L )} )}^{T} & 1\end{matrix} ] , {ε}_{\ddot{ρ}} {=}^{Δ} [ \begin{matrix}{ε}_{\ddot{ρ}}^{( 1 )} \\ {ε}_{\ddot{ρ}}^{( 2 )} \\ ⋮ \\ {ε}_{\ddot{ρ}}^{( L )}\end{matrix} ]$$

where \ddot{b}, Δ\ddot{x}, H, and ε_{\ddot{ρ}} represent the closed-form measurement vector, state error vector, design matrix and random error vector, respectively; superscript values {(1), (2), . . . (L)} denotes the set of channel indexes where L is the total channel number; subscript 0 denotes the initial or the previous iterative state estimates; \ddot{\hat{x}}, \ddot{ŷ}, and \ddot{\hat{z}} are the estimations of the user's acceleration navigation solutions in the three directions with respect to the ECEF frame; \tilde{μ}^{(L)} is the averaging Doppler rate measurements generated through the SR baseband MLE based on the S-LCI in the FrFD (as described in [1]), λ is the wavelength of the radio signal, \hat{l}^{(L)} is the unit vector from the a priori position to the satellite which is easy to be obtained. The 2nd-order pseudorange rate \ddot{\hat{r}}^{(L)} prediction can be computed as the following

$${\hat{\ddot{r}}}^{( L )} = ( {\hat{a}}^{( L )} - [ \begin{matrix}{\hat{\ddot{x}}}_{0} \\ {\hat{\ddot{y}}}_{0} \\ {\hat{\ddot{z}}}_{0}\end{matrix} ] ) \cdot {\hat{l}}^{( L )} \qquad ( 5 )$$

where a^{(L)} is the satellite acceleration in the ECEF frame which is computed through the ephemeris; [\ddot{\hat{x}}₀, \ddot{ŷ}₀, \ddot{\hat{z}}₀]^{T} is the a priori acceleration vector.

Finally, a standard NLS is used to estimate the user's acceleration and the clock drift rate as follows:

$$Δ \hat{\ddot{x}} = {( {H}^{T} H )}^{- 1} {H}^{T} \ddot{b} \\ \hat{\ddot{x}} = {\hat{\ddot{x}}}_{0} + Δ \hat{\ddot{x}}$$

where, ultimately, \ddot{\hat{x}} is the estimated states including the x-, y-, z-user's absolute acceleration and the clock drift rate and it is updated via the gradient descent optimization.

It should be noted that the nonlinear least-square (NLS) algorithm is not the only option for the disclosed present invention to compute the user's acceleration/deceleration. The other filters and optimizers that simultaneously use the Doppler rate measurements (generated from the block of “Baseband signal processors for satellites 1, . . . , N” mentioned above) and their closed-form models can replace the NLS estimator in the disclosed embodiment.

For clarity, any of the computational modules of the present invention may be embodied in a suitable processor mated with suitable software to execute the desired method.

In another aspect, the present invention therefore provides a satellite navigation accelerometer that offers navigation solutions for the user's absolute acceleration/deceleration with respect to the Earth coordinate frame as well as a timing solution for a user's clock drift rate (or the change of clock drift errors or the 2nd-order change of clock bias errors).

In the accelerometer system, a satellite navigation system (such as GNSS or LEO satellite system) antenna (or antenna array) receives radio signals transmitted from satellites. Then, front end equipment converts the received signals to digitized and quantified forms in the intermediate frequency. Baseband signal processors then process the received signals to produce measurements of the Doppler rate (or the change of Doppler shifts, or the 2nd-order change of carrier phases) for the multiple channels related to the available satellites. An acceleration/deceleration computer solves the user's absolute acceleration/deceleration and the clock drift rate based on the Doppler rate measurements and the direction cosine projections with respect to respective satellite position coordinates. The user's absolute position for the projection calculation is obtained either from the identical satellite navigation receiver or external-data-based navigation sources (such as inertial sensor navigation solutions with respect to the Earth coordinate frame or its combined results with the satellite navigation position solutions). A typical computer for the acceleration/deceleration results is based on the nonlinear least square (NLS) method. For this method, the unknown states include the clock drift rate and the user's acceleration at the three-dimension space in the Earth coordinates frame. Also for this method, the design matrix forms with the cosine direction vectors with respect to the antenna phase centers of respective satellites, and the measurement vector relates to the difference between the Doppler rates estimated from the baseband processor and their closed-form models.

As noted above, for a better understanding of the present invention, the following references may be consulted. Each of these references is hereby incorporated in their entirety by reference.
[1] Y. Luo, L.-T. Hsu, and N. El-Sheimy, “A Baseband MLE for Snapshot GNSS Receiver Using Super-Long-Coherent Correlation in a Fractional Fourier Domain,” NAVIGATION, vol. 70, no. 3, navi.588, April 2023, doi: 10.33012/navi.588.
[2] B. F. Thompson, S. W. Lewis, S. A. Brown, and T. M. Scott, “Computing GPS satellite velocity and acceleration from the broadcast navigation message,” NAVIGATION, vol. 66, no. 4, pp. 769-779, December 2019, doi: 10.1002/navi.342.
[3] P. Closas and A. Gusi-Amigo, “Direct Position Estimation of GNSS Receivers: Analyzing main results, architectures, enhancements, and challenges,” IEEE Signal Process Mag, vol. 34, no. 5, pp. 72-84, September 2017, doi: 10.1109/MSP.2017.2718040.
[4] P. D. Groves, Q. Zhong, R. Faragher, and P. Esteves, “Combining Inertially-aided Extended Coherent Integration (Supercorrelation) with 3D-Mapping-Aided GNSS,” in Proc. ION GNSS 2020, Institute of Naivigation, September 22-25, October 2020, pp. 2327-2346. doi: 10.33012/2020.17767.
[5] N. Krasner and P. McBurney, “Application of Super Resolution Correlation to Multipath Mitigation in an L5 Channel,” in Proceedings of the 35th International Technical Meeting of the Satellite Division of The Institute of Navigation (ION GNSS+ 2022), October 2022, pp. 3249-3269. doi: 10.33012/2022.18584.
[6] H. M. Ozaktas, O. Arikan, M. A. Kutay, and G. Bozdagt, “Digital computation of the fractional Fourier transform,” IEEE Transactions on Signal Processing, vol. 44, no. 9, pp. 2141-2150, 1996, doi: 10.1109/78.536672.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for determining a user's absolute acceleration/deceleration, the method comprising:
receiving received signals from a plurality of satellites;
extracting Doppler rate measurements for each of said plurality of satellites by baseband signal processing from said received signals;
determining position coordinates of each of said plurality of satellites;
determining an acceleration/deceleration of each of said plurality of satellites;
determining said user's absolute position;
determining direction cosine vector projections for each of said plurality of satellites based on said position coordinates of said plurality of satellites, said acceleration/deceleration of said plurality of satellites, and said user's absolute position; and
determining said user's absolute acceleration/deceleration based on said direction cosine vector projections for each of said plurality of satellites and said Doppler rate measurements for each of said plurality of satellites.

2. The method according to claim 1, wherein said user's absolute acceleration/deceleration is used in a satellite-based navigation application.

3. The method according to claim 1, wherein all of said determinations and measurements are based on an Earth-centric frame of reference.

4. The method according to claim 1, further comprising converting said received signals into an intermediate frequency prior to said determinations and measurements.

5. The method according to claim 1, wherein said step of determining said user's absolute position is executed by at least one of:
a standalone GNSS receiver,
an inertial navigation sensor that is calibrated into an Earth coordinate frame,
an integrated GNSS/inertial sensor navigation system, and
a navigation device using signals of opportunity other than GNSS signals.

6. The method according to claim 4, wherein said step of extracting Doppler rate measurements is executed by processing said signals converted into said intermediate frequency.

7. The method according to claim 1, wherein said step of determining acceleration/deceleration for each of said plurality of satellites is based on extracted ephemeris of each of said plurality of satellites extracted during baseband processing of signals from said each of said plurality of satellites.

8. The method according to claim 1, wherein said step of determining position coordinates for each of said plurality of satellites is based on extracted ephemeris of each of said plurality of satellites extracted during baseband processing of signals from said each of said plurality of satellites.

9. The method according to claim 1, wherein said step of determining said user's absolute acceleration/deceleration is based on nonlinear least squares regression.

10. The method according to claim 1, wherein said step of determining said user's absolute acceleration/deceleration is based on measurements and determinations for at least four satellites.

11. The method according to claim 1, wherein said plurality of satellites comprises at least four satellites.

12. A system for determining a user's absolute acceleration/deceleration, the system comprising:
a signal receiver for receiving received signals from a plurality of satellites;
a baseband signal processor for extracting Doppler rate measurements for each of said plurality of satellites from said received signals;
a data processor for extracting ephemeris for each of said plurality of satellites, said ephemeris being extracted as said baseband signal processor processes said received signals, said data processor determining position coordinates and acceleration/deceleration for each of said plurality of satellites based on said ephemeris;
a hardware module for determining said user's absolute position;
a first calculation module for determining direction cosine vector projections for each of said plurality of satellites based on said position coordinates of said plurality of satellites, said acceleration/deceleration of said plurality of satellites, and said user's absolute position;
a second calculation module for determining said user's absolute acceleration/deceleration based on said direction cosine vector projections for each of said plurality of satellites and said Doppler rate measurements for each of said plurality of satellites.

13. The system according to claim 12, wherein said first calculation module comprises a processor and computer readable media having encoded thereon computer readable and computer executable instructions that, when executed, calculates said direction cosine vector projections for each of said plurality of satellites.

14. The system according to claim 12, wherein said second calculation module comprises a processor and computer readable media having encoded thereon computer readable and computer executable instructions that, when executed, calculates said user's absolute acceleration/deceleration.

15. The system according to claim 14, wherein said computer readable and computer executable instructions are based on a nonlinear least squares regression.

16. The system according to claim 12, wherein said user's absolute acceleration/deceleration produced by said system is used in a satellite-based navigation application.

17. The system according to claim 12, wherein all of said determinations and measurements performed by said system are based on an Earth-centric frame of reference.

18. The system according to claim 12, wherein said hardware module comprises at least one of:
a standalone GNSS receiver,
an inertial navigation sensor that is calibrated into an Earth coordinate frame,
an integrated GNSS/inertial sensor navigation system, and
a navigation device using signals of opportunity other than GNSS signals.

19. Computer readable media having encoded thereon computer readable and computer executable instructions that, when executed, implements a method for determining a user's absolute acceleration/deceleration, the method comprising:
receiving received signals from a plurality of satellites;
extracting Doppler rate measurements for each of said plurality of satellites by baseband signal processing from said received signals;
determining position coordinates of each of said plurality of satellites;
determining an acceleration/deceleration of each of said plurality of satellites;
determining said user's absolute position;
determining direction cosine vector projections for each of said plurality of satellites based on said position coordinates of said plurality of satellites, said acceleration/deceleration of said plurality of satellites, and said user's absolute position; and
determining said user's absolute acceleration/deceleration based on said direction cosine vector projections for each of said plurality of satellites and said Doppler rate measurements for each of said plurality of satellites
